(19) United States
(12) Patent Application Publication
(10) Pub. No.: US 2016/0135253 A1
(43) Pub. Date: May 12, 2016

(54) HEATABLE MOLDED ARTICLES MADE FROM ELECTRICALLY CONDUCTIVE THERMOPLASTIC POLYURETHANE

(71) Applicant: BASF SE, Ludwigshafen (DE)

(72) Inventors: Zeljko TOMOVIC, Lemfoerde (DE); Frank PRISSOK, Lemfoerde (DE); Stefan ARENZ, Osnabrueck (DE)

(73) Assignee: BASF SE, Ludwigshafen (DE)

(21) Appl. No.: 14/898,304

(22) PCT Filed: Jun. 11, 2014
(86) PCT No.: PCT/EP2014/062096

§ 371 Date: Dec. 14, 2015

(30) Foreign Application Priority Data
Jun. 14, 2013 (EP) 13172116.9

(51) Int. Cl. H05B 3/14; B60S 1/38; B62D 1/04; H01B 1/24

(52) U.S. Cl. CPC H05B 3/146; H01B 1/24; B60S 1/3805; B62D 1/04

(57) ABSTRACT

The present invention relates to a method of using a composition (Z1) at least comprising an elastomer (E1) and an at least 90% carbon-based conductivity-conferring additive (A1) in the manufacture of an electrically heatable shaped article for the automotive sector, wherein said composition (Z1) has a Shore hardness A, determined as per DIN 53505, in the range from 30 to 95, an electric specific volume resistivity, determined as per ISO 3915, of below 1×10² ohm×cm and above 0.01 ohm×cm, and also a breaking extension, determined as per DIN 53504, of above 300%. The present invention further relates to a method of preparing an electrically heatable shaped article for the automotive sector comprising a composition (Z1) and also to electrically heatable shaped articles for the automotive sector comprising a composition (Z1).

The present invention relates to a method of using a composition (Z1) at least comprising an elastomer (E1) and an at least 90% carbon-based conductivity-conferring additive (A1) in the manufacture of an electrically heatable shaped article for the automotive sector, wherein said composition (Z1) has a Shore hardness A, determined as per DIN 53505, in the range from 30 to 95, an electric specific volume resistivity, determined as per ISO 3915, of below 1×10² ohm×cm and above 0.01 ohm×cm, and also a breaking extension, determined as per DIN 53504, of above 300%. The present invention further relates to a method of preparing an electrically heatable shaped article for the automotive sector comprising a composition (Z1) and also to electrically heatable shaped articles for the automotive sector comprising a composition (Z1). Preferred elastomers (E1) are polyurethanes, in particular thermoplastic polyurethanes.

The preparation of thermoplastic polyurethanes, hereinafter also abbreviated as TPUs, is common general knowledge. TPUs are partly crystalline materials of construction and are members of the class of thermoplastic elastomers. What is characteristic of polyurethane elastomers is the segmented construction of their macromolecules. The differences in the cohesive energy density of the segments will bring about, in the ideal case, a phase separation into crystalline “hard” and amorphous “soft” regions. It is the resulting two-phase structure which determines the properties of TPUs. Thermoplastic polyurethanes are plastics having a wide and varied field of use. For instance, TPUs are found in the automotive industry, for example in instrument panel skins, in self-supporting film/sheeting, in cable sheathing, in the leisure industry, as heelpieces, as functional and styling elements in sports shoes, as flexible component in rigid-flexible combinations and many and varied further uses.

To improve the properties of TPUs, it is known from the literature to introduce crosslinks into the TPU which lead to increased strengths, improved heat resistance, reduced tensile and compression sets, and an improvement in resistance to media of any kind, in resilience and in creep behavior.

The use of auxiliary and adjunct materials to establish certain physical properties is also known. WO 2008/116801 A1 relates to a method of preparing crosslinked polyurethanes having a Shore A hardness between 55 and 85 by a reaction of thermoplastic polyurethanes with compounds having isocyanate groups, wherein said reaction is carried out in the presence of a prepolymer representing the reaction product of isocyanates with isocyanate-reactive compounds having a molecular weight between 500 g/mol and 10 000 g/mol. The invention further relates to polyisocyanate polyaddition products, in particular fibers, tubing, cable sheathing, profiles, shaped articles and self-supporting film/sheeting obtainable by said method.

WO 2010/149636 A2 discloses polyurethanes based on a thermoplastic polyurethane and on an isocyanate admixed to the thermoplastic polyurethane, preferably by reaction. Said isocyanate is preferably an isocyanate concentrate having a functionality greater than 2. In WO 2010/149636 A2, the thermoplastic polyurethane has a hard phase content of from 0% to 5%, in particular from 2% to 4%, and the isocyanate is admixed at not less than 2 wt % to 20 wt %, more preferably 3 wt % to 15 wt %, in particular at not less than 3 wt % to 10 wt %, based on the polyurethane.

WO 2006/134138 A1 relates to a thermoplastic polyurethane comprising between 20 wt % and 70 wt % of isocyanate dissolved in said thermoplastic polyurethane, based on the overall weight of thermoplastic polyurethane comprising isocyanate, and also to methods of preparing this thermoplastic polyurethane comprising isocyanate. In WO 2006/134138 A1, thermoplastic polyurethane is preferably melted and then the isocyanate is incorporated in the melt, preferably homogeneously. WO 2006/134138 A1 also relates to methods of preparing polyurethanes.

DE 10 2012 203 994 A1 relates to antistatic or electrically conductive polyurethanes comprising carbon nanotubes and ionic liquids. DE 10 1012 203 994 A1 further relates to a method of preparing these polyurethanes and also to their use in the manufacture of, for example, rollers, self-supporting film/sheeting, floorcoverings, coatings, plates, moldings, profiles, rolls, wheels, tubing, trim components in automobiles, gaskets, belts, cable sheathing, fibers, cable plugs, bellows, shock-absorbing elements, electrically heatable moldings and shoe soles. WO 2005/082988 A1 likewise discloses a thermoplastic polyurethane comprising carbon nanotubes.

EP 0 831 117 A1 relates to the use of thermoplastic molding compositions based on 30 to 94 wt % of a polyoxymethylene homo- or copolymer and 6 to 10 wt % of carbon black having a DIN 53 601 pore volume (DBP adsorption) of not less than 350 ml/100 g and also, optionally, further components in the manufacture of electrically heatable moldings. EP 0 831 117 A1 further relates to the electrically heatable moldings obtainable thereby.

EP 0 571 868 A1 relates to the use, as flexible liner for containers for storing flammable liquids, of an at least single-layered electrically conductive thermoplastic polyurethane (TPU) film/sheeting comprising at least TPU as base raw material, carbon black having a BET surface area of not less than 600 m²/g and optionally the adjunct materials known for TPU and film/sheeting production.

The automotive sector in particular has an extensive need for component parts that are sufficiently soft to ensure full functionality. They have to exhibit this property not only at outside temperatures above freezing, but also at distinctly lower temperatures. Elastomers, in particular thermoplastic polyurethanes, frequently do not have the desired suppleness because of the use of adjunct materials to establish certain physical properties.

Especially automotive wiping blades, typically manufactured from crosslinked rubber or else from partially crosslinked thermoplastic polyurethanes, need inter alia a sufficient degree of softness and suppleness to thoroughly remove the water film from the windscreen.

Stiffening of wiping blades at low outside temperatures in winter reduces their wiping performance. At temperatures below 0° C., freezing water on the wiping blades additionally causes a distinct worsening in the wiping performance and/or renders any wiping impossible. Even when the windscreen glass is heated, ice will form on the exposed wipers.

The problem addressed by the present invention in relation to the prior art was therefore that of providing shaped articles which, for use in the automotive sector at different temperature ranges, have sufficient flexibility coupled with good strength. The shaped articles should in particular also have good resilience. The problem addressed by the present invention was further that of providing shaped articles that have the desired properties even at low outside temperatures.

The problem is solved according to the invention by a method of using a composition (Z1) at least comprising an elastomer (El) and an at least 90% carbon-based conductivity-conferring additive (A1) in the manufacture of an electrically heatable shaped article for the automotive sector, wherein said composition (Z1) has the following properties:
a Shore hardness A, determined as per DIN 53505, in the range from 30 to 95, an electric specific volume resistivity, determined as per ISO 3915, of below 1×10² ohm×cm and above 0.01 ohm×cm, and also
a breaking extension, determined as per DIN 53504, of above 300%.

It was found that, surprisingly, the method of using a composition (Z1) in the manner of the present invention leads to particularly advantageous shaped articles. The shaped articles have a high breaking extension and are sufficiently flexible for a very wide variety of uses. Moreover, the shaped articles obtained are electrically conductive. Owing to their special electrical specific volume resistivity, the shaped articles are electrically heatable, making it possible even at comparatively low outside temperatures to adjust the temperature of the shaped article per se in order to prevent any deterioration in certain properties, for example flexibility or suppleness. The temperature to which the shaped articles obtained according to the present invention are heatable is preferably in the range from 0° C. to 100° C., more preferably in the range from 10° C. to 60° C., yet more preferably in the range from 15° C. to 50° C. and yet still more preferably in the range from 20° C. to 40° C. What is essential here for the purposes of the present invention is that any heating of the molding be relative to the particular outside temperature. When, for example, the molding is situated in an outside temperature of −20° C., heating to 0° C. is perfectly possible according to the present invention.

Elastomer (E1) may for the purposes of the present invention utilize in principle any suitable elastomer that has a suitable portfolio of properties. Suitable elastomers (E1) include, for example, crosslinked elastomers, for example rubber, polyurethanes or else blends formed from various materials, for example blends formed from polyurethanes and at least one further elastomer or else blends of various polyurethanes, and also polyether block copolymers, polyester block copolymers and polyether amides. Polyurethanes, more preferably thermoplastic polyurethanes, are particularly useful as elastomer (E1) in the context of the present invention.

The present invention accordingly also provides the method of using a composition (Z1) as described above wherein said elastomer (E1) is a thermoplastic polyurethane.

Methods of preparing elastomers (E1), in particular thermoplastic polyurethanes, are common general knowledge. A preferable way to prepare the polyurethanes is by reacting (a) isocyanates with (b) isocyanate-reactive compounds having a number average molecular weight of from 0.5 kg/mol to 12 kg/mol and preferably with (c) chain extenders having a number average molecular weight of from 0.05 kg/mol to 0.499 kg/mol, optionally in the presence of (d) catalysts and/or (e) customary auxiliary materials.

There now follows a presentation of exemplarily preferred starting components and methods of preparing preferred polyurethanes. Those components of (a) isocyanates, (b) isocyanate-reactive compounds, (c) chain extenders and also optionally (d) catalysts and/or (e) customary auxiliary materials that are exemplarily preferred for preparing these polyurethanes will now be described. Isocyanates (a), isocyanate-reactive compounds (b) and, if used, chain extenders (c) are also referred to as structural components.

Organic isocyanates (a) may utilize commonly/generally known isocyanates, preference being given to aromatic, aliphatic, cycloaliphatic and/or araliphatic isocyanates, more preferably diisocyanates, preferably 2,2′-, 2,4′- and/or 4,4′-diphenylmethane diisocyanate (MDI), 1,5-naphthylene diisocyanate (NDI), 2,4- and/or 2, 6-tolylene diisocyanate (TDI), 3,3′-dimethylbiphenylene diisocyanate, 1,2-diphenylethane diisocyanate and/or phenylene diisocyanate, tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylenes 1,4-diisocyanate, 1-isocyanato-3,3,5-trimethyl-5-isocyanatomethyl-cyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate (H12MDI). Further preferably 2,2′-, 2,4′- and/or 4,4′-diphenylmethane diisocyanate (MDI), 1,5-naphthylene diisocyanate (NDI), 2,4- and/or 2,6-tolylene diisocyanate (TDI), hexamethylene diisocyanate (HDI), 4,4′-, 2,4′- and 2,2′-dicyclohexylmethane diisocyanate (H12MDI) and/or 1-isocyanato-3,3,5-trimethyl-5-isocyanatomethylcyclohexane IPDI, yet more preferably 4,4′-MDI. One preferred embodiment uses only one isocyanate to prepare a polyurethane, another preferred embodiment uses at least 2 different isocyanates for preparing the polyurethane.

Isocyanate-reactive compounds (b) may utilize commonly/generally known isocyanate-reactive compounds, preference being given to polyesterols, polyetherols and/or polycarbonate diols, which are also subsumed under the term “polyols”, having number average molecular weights of from 0.5 kg/mol to 12 kg/mol, preferably 0.6 kg/mol to 6 kg/mol, more preferably 0.8 kg/mol to 4 kg/mol, and preferably an average functionality of from 1.8 to 2.3, preferably 1.9 to 2.2, especially 2. The average functionality indicates the number of groups in a mixture which are present on average per molecule and react with the isocyanate group. These polyols form the soft phase component.

Chain extenders (c) may utilize commonly/generally known aliphatic, araliphatic, aromatic and/or cycloaliphatic compounds preferably with a number average molecular weight of from 0.05 kg/mol to 0.499 kg/mol, preferably 2-functional compounds, i.e., those molecules that have two isocyanate-reactive groups. Preference is given to diamines and/or alkanediols having 2 to 10 carbon atoms in the alkylene moiety, in particular 1,4-butanediol, 1,6-hexanediol, 1,3-propanediol, 1,2-ethylene glycol and/or di-, tri-, tetra-, penta-, hexa-, hepta-, octa-, nona- and/or decaalkylene glycols having up to 8 carbon atoms, preferably the corresponding oligo- and/or polypropylene glycols, while a preferred embodiment also utilizes mixtures of chain extenders. Chain extenders (c) combine with isocyanates (a) to form the hard phase component.

Suitable catalysts (d) for speeding in particular the reaction between the NCO groups of isocyanates (a), preferably of the diisocyanates, and the hydroxyl groups of structural components (b) and (c) include the customary tertiary amines which are known from the prior art, preference being given to triethylamine, dimethylcyclohexylamine, N-methylmorpholine, N,N′-dimethylpiperazine, 2-(dimethylaminoethoxy)ethanol, diazabicyclo-(2,2,2)-octane and the like, and also, more particularly, organic metal compounds such as titanic esters, iron compounds, preferably iron(III) acetylacetonate, tin compounds, preferably tin diacetate, tin dioctoate, tin dilaurate or the tin dialkyl salts of aliphatic carboxylic acids, preferably dibutyltin diacetate, dibutyltin dilaurate or the like. Catalysts are customarily used in amounts of 0.00001 to 0.1 part by weight per 100 parts by weight of polyhydroxy compound (b).

In addition to catalysts (d), customary auxiliaries (e) are also added to the structural components (a) to (c) in preferred embodiments. Useful auxiliaries (e) include for example surface-active substances, flame retardants, nucleators, oxidation stabilizers, lubricating and demolding aids, dyes and pigments, stabilizers, for example against hydrolysis, light, heat or discoloration, organic and inorganic fillers, reinforcing agents and plasticizers.

Hydrolysis control agents used are preferably oligomeric and/or polymeric aliphatic or aromatic carbodiimides. To stabilize a polyurethane against aging, the polyurethane preferably has stabilizers added to it. Stabilizers for the purposes of the present invention are additives that protect a plastic or a mixture of plastics against harmful environmental effects. Examples are primary and secondary antioxidants, hindered amine light stabilizers, UV absorbers, hydrolysis control agents, quenchers and flame retardants. Examples of commercial hydrolysis control agents and stabilizers are for example given in the Plastics Additive Handbook, 5th Edition, H. Zweifel, ed., Hanser Publishers, Munich, 2001 ([1]), p. 98-p. 136.

When the TPU of the present invention is exposed to thermal oxidative damage during use, antioxidants may be added. Preference is given to using phenolic antioxidants. Examples of phenolic antioxidants are given in Plastics Additive Handbook, 5th edition, H. Zweifel, ed, Hanser Publishers, Munich, 2001, pp. 98-107 and pp. 116-121. Preference is given to those phenolic antioxidants that have a molecular weight greater than 700 g/mol. One example of a phenolic antioxidant that is used with preference is pentaerythrityl tetrakis(3-(3,5-bis(1,1-dimethylethyl)-4-hydroxyphenyl) propionate) (Irganox® 1010). Phenolic antioxidants are generally used in concentrations between 0.1 and 5 wt %, preferably between 0.1 and 2 wt %, especially between 0.5 and 1.5 wt %, all based on total TPU weight. TPUs are preferably additionally stabilized with a UV absorber. UV absorbers are molecules that absorb high energy UV light and dissipate the energy. UV absorbers widely used in industry come for example from the group of cinnamic esters, diphenyl cyanoacrylates, formamidines, benzylidene malonates, diarylbutadienes, triazines and also benzotriazoles. Examples of commercial UV absorbers are found in Plastics Additive Handbook, 5th edition, H. Zweifel, ed, Hanser Publishers, Munich, 2001, pages 116-122. In one preferred embodiment, UV absorbers have a number average molecular weight of greater than 300 g/mol, especially greater than 390 g/mol. UV absorbers that are used with preference should further have a molecular weight of not greater than 5000 g/mol, more preferably not greater than 2000 g/mol. The group of benzotriazoles is particularly useful as UV absorbers. Examples of particularly useful benzotriazoles are Tinuvin® 213, Tinuvin® 328, Tinuvin® 571, and Tinuvin® 384 and Eversorb®82. UV absorbers are preferably added in amounts between 0.01 and 5 wt %, based on total TPU mass, more preferably at between 0.1 and 2.0 wt %, especially at between 0.2 and 0.5 wt %, all based on total TPU weight. Often, an above-described UV stabilization based on an antioxidant and a UV absorber is still not sufficient to ensure good stability for the TPU of the present invention against the harmful influence of UV rays. In this case, a hindered amine light stabilizer (HALS) may preferably be added to component (e) to the TPU of the present invention in addition to the antioxidant and the UV absorber. The activity of HALS compounds rests on their ability to form free nitroxyl radicals, this ability intervenes in the mechanism of the oxidation of polymers. HALSs are deemed to be highly efficient UV stabilizers for most polymers. HALS compounds are common general knowledge and commercially available. Examples of commercially available HALS stabilizers are found in Plastics Additive Handbook, 5th edition, H. Zweifel, Hanser Publishers, Munich, 2001, pp. 123-136. Preference for use as hindered amine light stabilizers is given to hindered amine light stabilizers whose number average molecular weight is greater than 500 g/mol. The molecular weight of preferred HALS compounds should further preferably not be greater than 10 000 g/mol, more preferably not greater than 5000 g/mol.

Particularly preferred hindered amine light stabilizers are bis(1,2,2,6,6-pentamethylpiperidyl) sebacat (Tinuvin® 765, Ciba Spezialitatenchemie AG) and the condensation product of 1-hydroxyethyl-2,2,6,6-tetramethyl-4-hydroxypiperidine and succinic acid (Tinuvin® 622). Particular preference is given to the condensation product formed from 1-hydroxyethyl-2,2,6,6-tetramethyl-4-hydroxypiperidine and succinic acid (Tinuvin® 622), when the titanium content of the product is <150 ppm, preferably <50 ppm, more preferably <10 ppm. HALS compounds are preferably employed in a concentration between 0.01 and 5 wt %, more preferably at between 0.1 and 1 wt %, yet more preferably between 0.15 and 0.3 wt %, all based on total TPU weight. A particularly preferred UV stabilization comprises a mixture comprising a phenolic stabilizer, a benzotriazole and an HALS compound in the preferred amounts described above.

Any plasticizers known for use in TPUs are usable. They include, for example, compounds comprising at least one phenolic group. Compounds of this type are described in EP 1 529 814 A2. It is further also possible to use, for example, polyesters having a molecular weight of about 500 to 1500 g/mol and based on dicarboxylic acids, benzoic acid and at least one di- or triol, preferably one diol. The diacid component used is preferably succinic acid, glutaric acid, adipic acid, suberic acid, azelaic acid, decanedicarboxylic acid, maleic acid, fumaric acid, phthalic acid, isophthalic acid and/or terephthalic acid, while the diol used is preferably 1,2-ethanediol, diethylene glycol, 1,2-propanediol, 1,3-propanediol, dipropylene glycol, 1,4-butanediol, 1,5-pentanediol and/or 1,6-hexanediol. And the ratio of dicarboxylic acid to benzoic acid is preferably in the range from 1:10 to 10:1. Plasticizers of this type are more particularly described in EP 1 556 433 A1 for example.

Further particulars on the abovementioned auxiliaries and adjunct materials are found in the technical literature, for example Plastics Additive Handbook, 5th edition, H. Zweifel, ed, Hanser Publishers, Munich, 2001. Molecular weights recited herein are all number average molecular weights and, unless otherwise stated, have the unit of [kg/mol].

To establish a hardness setting for a polyurethane, structural components (b) and (c) may be varied across relatively broad molar ratios. Molar ratios of from 10:0 to 1:0.35 for component (b) to total chain extenders (c) to be used have been found to be advantageous, the hardness of the polyurethane increasing with increasing (c) content.

The TPUs are obtainable in a known manner by a batch operation or by a continuous operation, preferably using reactive extruders or the belt process by the one shot or the prepolymer process. The preparation via the prepolymer process is likewise preferable. In these processes, the reactant components (a), (b) and optionally (c), (d) and/or (e) can be mixed in succession or at the same time, and the reaction ensues immediately.

In the extruder process, structural components (a), (b) and also optionally (c) and also components (d) and/or (e) are introduced into the extruder individually or as a mixture and preferably reacted at temperatures of 100° C. to 280° C., more preferably at 140° C. to 250° C. The TPU obtained is extruded, cooled down and pelletized.

In a particularly preferred embodiment, the thermoplastic polyurethane is based on an MDI as polyisocyanate and a polyesterol and/or polyetherol, in particular a polyester of adipic acid with butanediol and/or ethylene glycol and/or methylpropanediol or a polyether based on polytetrahydrofuran.

In a further embodiment, the present invention also provides the method of using a composition (Z1) as described above wherein said elastomer (E1) is a thermoplastic polyurethane based on at least one isocyanate, at least one polyol component having a molecular weight of above 500 g/mol and at least one second polyol component having a molecular weight of below 499 g/mol.

Polyurethanes of this type are known in principle and have particularly good flexibility and elongation at break. Polyurethanes preferred for use in the present invention are for example disclosed in WO 2010/149636 A2.

In a particularly preferred embodiment, the thermoplastic polyurethane has an index of 980 to 1200. The index is defined by the molar ratio of total component (a) isocyanate groups used in the reaction to the isocyanate-reactive groups, i.e., the active hydrogens, of component (b) and optionally chain extender (c). Optionally here is to be understood as meaning that the chain extender is taken into account provided it has been added. An index of 1000 means that for each isocyanate group of component (a) there is one active hydrogen atom, i.e., one isocyanate-reactive function, on components (b) and (c). When the index is above 1000, there are more isocyanate groups present than groups having active hydrogen atoms, e.g., OH groups.

Composition (Z1) used according to the present invention comprises at least one at least 90% carbon-based conductivity-conferring additive (A1). Any at least 90% carbon-based conductivity-conferring additives known to a person skilled in the art are in principle useful as an at least 90% carbon-based conductivity-conferring additive (A1). For the purposes of the present invention, the at least 90% carbon-based conductivity-conferring additive (A1) is preferably selected from the group consisting of carbon nanotubes, graphene and conductivity grade carbon black or mixtures thereof. The use of carbon nanotubes or graphene is preferred and that of carbon nanotubes is particularly preferred.

In a further embodiment, the present invention also provides the method of using a composition (Z1) as described above wherein said at least 90% carbon-based conductivity-conferring additive (A1) is selected from the group consisting of carbon nanotubes, graphene and conductivity grade carbon black and mixtures thereof.

In a preferred embodiment, the present invention also provides the method of using a composition (Z1) as described above wherein the at least 90% carbon-based conductivity-conferring additive (A1) is selected from the group consisting of carbon nanotubes, graphene and mixtures thereof. It is particularly preferable for said composition (Z1) not to comprise any further carbon-based conductivity-conferring additives besides carbon nanotubes and graphene in the context of the present invention.

According to the present invention, the conductivity-conferring additive (A1) is present in the composition in a very finely subdivided form. The amount of the conductivity-conferring additive employed therein can vary according to the present invention. Preferably, the additive is employed in an amount of 0.1 to 30 wt % based on the total weight of the mixture. The preferred amount used of conductivity-conferring additive (A1) can vary according to the type of conductivity-conferring additive (A1).

In a further embodiment, the present invention also provides the method of using a composition (Z1) as described above wherein carbon nanotubes are employed as said at least 90% carbon-based conductivity-conferring additive (A1).

When carbon nanotubes are employed as conductivity-conferring additive, they are preferably in a very fine state of subdivision. Carbon nanotubes, or CNTs, according to the prior art are mainly cylindrical tubes of carbon which are between 3 and 100 nm in diameter and have a length that is a multiple of the diameter. Carbon nanotubes consist of one or more layers of ordered carbon atoms and have a morphologically different core. Carbon nanotubes are for example also known as “carbon fibrils” or “hollow carbon fibers”.

Carbon nanotubes are well known in the technical literature. Customary structures for these carbon nanotubes are those of the cylinder type. Among the cylindrical structures, a distinction is made between single wall carbon nanotubes and the cylindrical multiwall carbon nanotubes. Examples of common processes for their production are the arc discharge process, the laser ablation process, the chemical vapor deposition (CVD) process and the catalytic chemical vapor deposition (CCVD) process.

The formation of carbon nanotubes in the arc discharge process is also known per se, the carbon nanotubes obtained consisting of two or more layers of graphite and are rolled up to form a seamlessly closed cylinder and are nested inside each other. Depending on the roll-up vector, chiral and achiral arrangements of the carbon atoms are possible in relation to the longitudinal axis of the carbon fiber. Structures are possible where individual coherent layers of graphite (the so-called “scroll type”) or interrupted layers of graphite (the so-called “onion type”) form the basis for the construction of the nanotube.

Carbon nanotubes for the purposes of the invention are any single wall or multiwall carbon nanotubes of the cylinder type, scroll type or of onion-type structure. Preference is given to using multiwall carbon nanotubes of the cylinder type, the scroll type or mixtures thereof.

Particular preference is given to using carbon nanotubes having an above 5, preferably above 10 ratio of length to outside diameter.

The carbon nanotubes to be used, which may be in the form of agglomerates, preferably have an average external diameter of 1 to 50 nm, preferably 2 to 30 nm, more preferably 3 to 20 nm and especially 4 to 15 nm in the non-agglomerated form.

In addition to carbon nanotubes of the scroll type, with just one continuous or interrupted layer of graphite, there are also carbon nanotube structures that consist of two or more layers of graphite, which are stacked together and rolled up (the multiscroll type). This carbon nanotube structure relates to the carbon nanotubes of the simple scroll type like the cylindrical MWNT structure relates to the cylindrical SWNT structure.

Suitable processes for preparing carbon nanotubes are in principle known in the prior art. A particularly preferred process for preparing carbon nanotubes is known from WO 2006/050903 A2, EP 1401763, EP 1594802, EP 1827680 and WO 2007/0033438.

Multiwall carbon nanotubes are used with particular preference. Nanocyl® 7000 from Nanocyl SA, Belgium, is a preferred example of such multiwall carbon nanotubes.

The carbon nanotube content of composition (Z1) used according to the present invention is preferably in the range from 0.1 to 20 wt %, more preferably from 0.5 to 15 wt %, yet more preferably from 1 to 10 wt %, yet still more preferably from 1 to 7 wt % and especially from 2 to 7 wt %, based on the total weight of composition (Z1).

In a further embodiment, composition (Z1) comprises no further carbon-based conductivity-conferring additives besides carbon nanotubes in the context of the present invention.

Similarly, composition (Z1) used according to the invention may comprise conductivity grade carbon black as an at least 90% carbon-based conductivity-conferring additive (A1).

Carbon black is an amorphous form of carbon that has a large ratio of surface area to volume. Carbon black is obtained by incomplete combustion of heavy oil products, for example FCC tar, coal tar, ethylene cracking tar and from vegetable oil in minor amounts. Any customary form of carbon black is usable in the context of the present invention. Commercially available products such as Ketjenblack® EC-600JD from AkzoNobel or Printex® XE2-B from Orion Engineered Carbons are suitable in the context of the present invention, for example.

Graphitic layers in the amorphous carbon render carbon black sufficiently conductive. Current is conducted within and between individual particles of carbon black given a sufficiently low separation. To achieve sufficient conductivity at minimal quantities of carbon black, it is preferable to employ carbon black comprising anisotropic structures. In this type of carbon black, the required conductivity is achieved even at low proportion of the carbon black in the final material. Suitable materials are described in D. Pantea et al., Applied Surface Science 2003, 217, 181-193.

Electrical conductivity increases with increasing carbon black concentration, whereas electrical resistance decreases correspondingly. The carbon black which is suitable for the purposes of the present invention is used in amounts such that the composition (Z1) comprises from 5 to 30 wt %, preferably from 7 to 25 wt % of carbon black, more preferably from 10 to 20 wt % of carbon black, based on the total weight of composition (Z1).

For the purposes of the present invention, composition (Z1) may also comprise graphene as conductivity-conferring additive. Graphene is a monolayer of carbon atoms arranged in a honeycomb-shaped structure. For the purposes of the present invention, however, graphene is not to be understood as referring to graphene within the meaning of the IUPAC definition, but to a composition comprising mono-ply material, two-ply material and multi-ply material having 3 to 10 plies and exceptionally up to 20 plies. The proportion of the different components, i.e., mono-ply material, two-ply material and multi-ply material, is dependent on the method of production. For the purposes of the present invention, the term graphene is to be understood as referring to a material that is characterized by the absence of the graphite signal in an XRD measurement.

The presence of a signal at 2theta=25 to 30° (precise signal at 26.3° , with Cu Ka radiation, wavelength=0.154 nm) results from the layered structure and correlates with the proportion of graphite. Preferably, the corresponding measurement in respect of the graphene in the context of the present invention is free from any graphite signal. Accordingly, the material herein preferably does not have any defoliated material.

“Graphene” for the purposes of the present invention is further characterized by a low density, preferably of not more than 0.2 g/cm³, for example in the range from 0.001 to 0.2 g/cm³ or from 0.003 to 0.2 g/cm³, more preferably not more than 0.15 g/cm³, for example in the range from 0.001 to 0.15 g/cm³ or from 0.003 to 0.15 g/cm³, more preferably not more than 0.1 g/cm³, for example in the range from 0.001 to 0.1 g/cm³ or from 0.003 to 0.1 g/cm³, in particular not more than 0.05 g/cm³, for example in the range from 0.001 to 0.05 g/cm³ or from 0.003 to 0.05 g/cm³, and most preferably not more than 0.01 g/cm³, for example in the range from 0.001 to 0.01 g/cm³ or from 0.003 to 0.01 g/cm³.

“Graphene” for the purposes of the present invention is further characterized by a high BET (Brunauer-Emmett-Teller) surface area. The BET surface area is preferably greater than 200 m²/g, for example in the range from 200 to 2600 or in the range from 200 to 2000 or in the range from 200 to 1500 m²/g or in the range from 200 to 700 m²/g; more preferably the BET surface area is greater than 300 m²/g, for example in the range from 300 to 2600 or in the range from 300 to 2000 or in the range from 300 to 1500 or in the range from 300 to 700 m²/g.

In the context of the present invention, suitable “graphene” preferably has a high C/O ratio, i.e., ratio of carbon atoms to oxygen atoms. The elemental composition is reflected by the ratio of carbon atoms to oxygen atoms (C/O ratio) and correlates with the degree of reduction for the graphene material. The ratio of carbon atoms to oxygen atoms is preferably not less than 3:1, more preferably not less than 5:1, yet more preferably not less than 50:1, yet still more preferably not less than 100:1 and most preferably not less than 500:1, as determined by the atomic proportions (at %) of the elements as per x-ray photoelectron spectroscopy (XPS).

Suitable materials and methods of production are described for example in Macromolecules 2010, 43, pages 6515 to 6530, in WO 2009/126592, J. Phys. Chem. B 2006, 110, 8535-8539, Chem. Mater. 2007, 19, 4396-4404 and in the prior art cited therein.

The graphene content of composition (Z1) used according to the present invention is preferably in the range from 0.1 to 20 wt %, more preferably in the range from 0.5 to 15 wt %, yet more preferably in the range from 1 to 10 wt %, yet still more preferably in the range from 1 to 7 wt % or in the range from 2 to 7 wt %, all based on the total weight of composition (Z1).

It is particularly preferable for composition (Z1) to not comprise any further carbon-based conductivity-conferring additives besides graphene in the context of the present invention.

Composition (Z1) used according to the present invention is obtainable in a conventional manner, and is preferably obtained using a kneader or an extruder, for example a twin-screw extruder.

Incorporation of additives (A1) may be effected using what is known as “Feed Enhancement Technology” (FET) as described by Paul Anderson in “Plastics Research Online”, Soc. of Plastic Engineers (2011), 10.1002/spepro.003681 or in US 20080248152 and in US 20100202243. Extruders equipped with FET technology are commercially available from Coperion GmbH, Stuttgart.

To improve the dispersion of the additives used, it is further also possible to employ processing aids, such as surface-active substances, for example anionic, cationic or nonionic surfactants.

According to the present invention, the breaking extension of composition (Z1) used is greater than 300%, as determined according to DIN 53504. The breaking extension is preferably greater than 500% and more preferably greater than 600%.

The present invention accordingly also provides the method of using a composition (Z1) as described above wherein said composition (Z1) has a breaking extension, determined as per DIN 53504, in the range above 500%.

Composition (Z1) used according to the present invention is further characterized in preferred embodiments in that at least one of the following properties is fulfilled:
The tensile strength is greater than 5 MPa, preferably above 10 MPa and more preferably greater than 20 MPa.
The tongue tear resistance is above 10 kN/m, preferably greater than 15 kN/m and more preferably not less than 25 kN/m.
The abrasion loss is less than 100 mm³, preferably less than 70 mm³ and more preferably less than 55 mm³.
The compression set is less than 40% at 23° C., preferably less than 30% and more preferably less than 24%.
The compression set at 70° C. is less than 50%, preferably less than 35% and more preferably less than 25%.
The bending angle at 23° C. is less than 50%, preferably less than 30% and more preferably less than 20%.

In particularly preferred embodiments, composition (Z1) has at least two of the abovementioned properties, more preferably at least three, more preferably at least four, more preferably at least 5, yet more preferably at least 6 and most preferably all 7 of the abovementioned properties. Every possible combination of properties whether at the same or else at a different level of preference, e.g., “preferably” with “preferably”, but also “preferably” with “more preferably” etc., shall also form part of this disclosure even though not every one of these combinations is expressly recited for reasons of clarity. It is very particularly preferable for the polyurethanes of the present invention to have a tensile strength of more than 20 MPa, a breaking extension of more than 500%, a tongue tear resistance of not less than 25 kN/m, an abrasion loss of less than 55 mm³, and a compression set of less than 24% at 23° C. and of less than 25% at 70° C.

The polyurethanes in composition (Z1) used according to the present invention preferably have an index KZ between 980 and 1200, more preferably between 980 and 1100 and yet more preferably between 990 and 1050.

The Shore hardness A of composition (Z1) used according to the present invention is herein in the range from 30 to 95, preferably in the range from 40 to 85, more preferably in the range from 45 to 80, all determined according to DIN 53505.

In a further embodiment, the present invention thus also provides the method of using a composition (Z1) as described above wherein said composition (Z1) has a Shore hardness A, determined as per DIN 53505, in the range from 40 to 85.

Composition (Z1) used according to the present invention further has an electric specific volume resistivity, determined according to ISO 3915, in the range of below 1×10² ohm×cm and above 0.01 ohm×cm. The electric specific volume resistivity, determined according to ISO 3915, is preferably in the range from 0.01 to 100 ohm×cm, preferably in the range from 0.05 to 50 ohm×cm, more preferably in the range from 0.05 to 10 ohm×cm, most preferably in the range from 0.1 to 5 ohm×cm.

According to the present invention, composition (Z1) is used in the manufacture of shaped articles in the automotive sector, for example rollers, trim components in automobiles, tubing, coatings, profiles, laminates, bellows, drag cables, stripper devices, sealing lips, cable sheathing, gaskets, belts, frames, housings, containers, nozzle jackets or shock-absorbing elements as obtained by injection molding, calendering, hot pressing, powder sintering or extrusion.

In a further embodiment, the present invention also provides the method of using a composition (Z1) as described above wherein said composition (Z1) is used in the manufacture of a stripper device, a wiping blade, a sealing lip, a steering wheel, a gasket or a component part for an automotive seat or an armrest.

The present invention also provides a method of preparing an electrically heatable shaped article for the automotive sector, comprising the steps of
(i) providing a composition (Z1) at least comprising an elastomer (E1) and an at least 90% carbon-based conductivity-conferring additive (A1) in the manufacture of an electrically heatable shaped article for the automotive sector, wherein said composition (Z1) has the following properties:
   a Shore hardness A, determined as per DIN 53505, in the range from 30 to 95,
   an electric specific volume resistivity, determined as per ISO 3915, of below 1×10² ohm×cm and above 0.01 ohm×cm, and also
   a breaking extension, determined as per DIN 53504, of above 300%,
(ii) shaping said composition (Z1).

Regarding preferred embodiments, the above remarks are referenced.

According to the present invention, composition (Z1) is prepared from an elastomer (E1), preferably a thermoplastic polyurethane, and said conductivity-conferring additive (A1) on a kneader or twin-screw extruder.

In a further embodiment of the present invention, the conductivity-conferring additive (A1) may also be added to elastomer (E1) in the form of a concentrate prior to shaping.

Step (ii) is the shaping step. The shaping step of the present invention preferably comprises for example melting said composition (Z1) and processing the melt in an extruder or in an injection molding or compression molding process.

It is also possible for the purposes of the present invention that the shaped article obtained is merely part of a component part and said composition (Z1) is for example applied to an existing frame.

The present invention also provides electrically heatable shaped articles for the automotive sector, comprising a composition (Z1) at least comprising an elastomer (E1) and an at least 90% carbon-based conductivity-conferring additive (A1) in the manufacture of an electrically heatable shaped article for the automotive sector, wherein said composition (Z1) has the following properties:
a Shore hardness A, determined as per DIN 53505, in the range from 30 to 95,
an electric specific volume resistivity, determined as per ISO 3915, of below 1×10² ohm×cm and above 0.01 ohm×cm, and also
a breaking extension, determined as per DIN 53504, of above 300%.

This shaped article is preferably a stripper device, a wiping blade, a sealing lip, a steering wheel, a component part for an automotive seat or an armrest or a gasket in the context of the present invention. Accordingly, the present invention also provides shaped articles as described above wherein said shaped article is a stripper device, a wiping blade, a sealing lip, a steering wheel, a component part for an automotive seat or an armrest or a gasket.

The compositions used according to the present invention and/or the shaped articles obtained according to the present invention are preferably heatable to a temperature in the range from 0° C. to 100° C., more preferably to a temperature in the range from 10° C. to 60° C., yet more preferably to a temperature in the range from 15° C. to 50° C. and yet still more preferably in the range from 20 to 40° C. In a preferred embodiment, a surface temperature of 30° C. becomes established in a shaped article having a cross section of 10 mm² within 5 minutes from applying a voltage of 12 V across a current flow path of 10 cm.

The invention provides at least two contacts to heat the molding by applying a voltage. It is also possible for a current to flow through only part of the shaped article, or for there to be more than two contacts, for example 3, 4, 5 or 6 contacts. For example, an extruded wiping blade may be formed from a composition (Z1) and be equipped with an electrical terminal at either end. By applying low voltage from the passenger car's on-board network, a wiping blade of this type can be heated up to 60° C., the desired temperature setting being obtainable by means of an input resistor and/or a voltage control system. On wiping blades thus heated, ice will no longer form at temperatures below freezing, and the material-internal heating is likewise able to prevent the familiar stiffening of thermoplastic elastomers at distinctly below 0° C.

In a further embodiment, the present invention accordingly also provides a shaped article as described above wherein said shaped article is heated by applying a direct or alternating current voltage from the automotive on-board network. The present invention in a further embodiment further also provides a shaped article as described above wherein the temperature control of the shaped article is effected by adapting the voltage or changing an input resistance.

The present invention also provides a method of electrically heating a shaped article for the automotive sector by applying a direct or alternating current voltage from the automotive on-board network. The present invention further also provides a method of temperature control for a shaped article in the automotive sector wherein the temperature control of the shaped article is effected by adapting the voltage or changing an input resistance.

Further embodiments of the present invention are derivable from the claims and the examples. It will be understood that the aforementioned and hereinbelow elucidated features of the article/method/uses according to the present invention can be used not just in the particular combination recited, but also in other combinations, without departing from the realm of the invention. For instance, the combination of a preferred feature with a particularly preferred feature or of a not further characterized feature with a particularly preferred feature, etc., is also implicitly comprehended even when this combination is not expressly mentioned.

1. A method of using a composition (Z1) at least comprising an elastomer (E1) and an at least 90% carbon-based conductivity-conferring additive (A1) in the manufacture of an electrically heatable shaped article for the automotive sector, wherein said composition (Z1) has the following properties:
a Shore hardness A, determined as per DIN 53505, in the range from 30 to 95,
an electric specific volume resistivity, determined as per ISO 3915, of below 1×10² ohm×cm and above 0.01 ohm×cm, and also
a breaking extension, determined as per DIN 53504, of above 300%.

2. The method of using a composition (Z1) according to embodiment 1 wherein said elastomer (E1) is a thermoplastic polyurethane.

3. The method of using a composition (Z1) according to embodiment 1 or 2 wherein said elastomer (E1) is a thermoplastic polyurethane based on at least one isocyanate, at least one polyol component having a molecular weight of above 500 g/mol and at least one second polyol component having a molecular weight of below 499 g/mol.

4. The method of using a composition (Z1) according to any of embodiments 1 to 3 wherein said at least 90% carbon-based conductivity-conferring additive (A1) is selected from the group consisting of carbon nanotubes, graphene and conductivity grade carbon black and mixtures thereof.

5. The method of using a composition (Z1) according to any of embodiments 1 to 4 wherein carbon nanotubes are employed as said at least 90% carbon-based conductivity-conferring additive (A1).

6. The method of using a composition (Z1) according to any of embodiments 1 to 5 wherein said at least 90% carbon-based conductivity-conferring additive (A1) is present in said composition (Z1) in an amount ranging from 0.1 to 30 wt %, based on the entire composition (Z1).

7. The method of using a composition (Z1) according to any of embodiments 1 to 6 wherein said composition (Z1) has a Shore hardness A, determined as per DIN 53505, in the range from 40 to 85.

8. The method of using a composition (Z1) according to any of embodiments 1 to 7 wherein said composition (Z1) has a breaking extension, determined as per DIN 53504, in the range above 500%.

9. The method of using a composition (Z1) according to any of embodiments 1 to 8 wherein said composition (Z1) has an electric specific volume resistivity, determined as per ISO 3915, in the range from 0.1 to 5 ohm×cm.

10. The method of using a composition (Z1) according to any of embodiments 1 to 9 wherein said composition (Z1) is used in the manufacture of a stripper device, a wiping blade, a sealing lip, a steering wheel, a gasket or a component part for an automotive seat or an armrest.

11. A method of preparing an electrically heatable shaped article for the automotive sector, comprising the steps of
(i) providing a composition (Z1) at least comprising an elastomer (E1) and an at least 90% carbon-based conductivity-conferring additive (A1) in the manufacture of an electrically heatable shaped article for the automotive sector, wherein said composition (Z1) has the following properties:
   a Shore hardness A, determined as per DIN 53505, in the range from 30 to 95,
   an electric specific volume resistivity, determined as per ISO 3915, of below ×10² ohm×cm and above 0.01 ohm×cm, and also
   a breaking extension, determined as per DIN 53504, of above 300%,
(ii) shaping said composition (Z1).

12. An electrically heatable shaped article for the automotive sector, comprising a composition (Z1) at least comprising an elastomer (E1) and an at least 90% carbon-based conductivity-conferring additive (A1) in the manufacture of an electrically heatable shaped article for the automotive sector, wherein said composition (Z1) has the following properties:
a Shore hardness A, determined as per DIN 53505, in the range from 30 to 95,
an electric specific volume resistivity, determined as per ISO 3915, of below 1×10² ohm×cm and above 0.01 ohm×cm, and also
a breaking extension, determined as per DIN 53504, of above 300%.

13. The shaped article according to embodiment 12 wherein said shaped article is a stripper device, a wiping blade, a sealing lip, a steering wheel, a component part for an automotive seat or an armrest or a gasket.

14. The shaped article according to embodiment 12 or 13 wherein said shaped article is heated by applying a direct or alternating current voltage from the automotive on-board network.

15. The shaped article according to any of embodiments 12 to 14 wherein the temperature control of the shaped article is effected by adapting the voltage or changing an input resistance.

16. A method of using a composition (Z1) at least comprising an elastomer (E1) and an at least 90% carbon-based conductivity-conferring additive (A1) in the manufacture of an electrically heatable shaped article for the automotive sector, wherein the at least 90% carbon-based conductivity-conferring additive (A1) is selected from the group consisting of carbon nanotubes, graphene and mixtures thereof, and

wherein said composition (Z1) has the following properties:
a Shore hardness A, determined as per DIN 53505, in the range from 30 to 95,
an electric specific volume resistivity, determined as per ISO 3915, of below 1×10² ohm×cm and above 0.01 ohm×cm, and also
a breaking extension, determined as per DIN 53504, of above 300%.

17. The method of using a composition (Z1) according to embodiment 16 wherein carbon nanotubes are employed as said at least 90% carbon-based conductivity-conferring additive (A1).

18. The method of using a composition (Z1) according to either of embodiments 16 and 17 wherein said at least 90% carbon-based conductivity-conferring additive (A1) is present in said composition (Z1) in an amount ranging from 2 to 7 wt %, based on the entire composition (Z1).

19. An electrically heatable shaped article for the automotive sector comprising a composition (Z1) at least comprising an elastomer (El) and an at least 90% carbon-based conductivity-conferring additive (A1) in the manufacture of an electrically heatable shaped article for the automotive sector, wherein the at least 90% carbon-based conductivity-conferring additive (A1) is selected from the group consisting of carbon nanotubes, graphene and mixtures thereof, and

wherein said composition (Z1) has the following properties:
a Shore hardness A, determined as per DIN 53505, in the range from 30 to 95,
an electric specific volume resistivity, determined as per ISO 3915, of below 1×10² ohm×cm and above 0.01 ohm×cm, and also
a breaking extension, determined as per DIN 53504, of above 300%.

20. The shaped article according to embodiment 19 wherein said shaped article is a stripper device, a wiping blade, a sealing lip, a steering wheel, a component part for an automotive seat or an armrest or a gasket.

21. The shaped article according to embodiment 19 or 20 wherein said shaped article is heated by applying a direct or alternating current voltage from the automotive on-board network.

22. The shaped article according to any of embodiments 19 to 21 wherein the temperature control of the shaped article is effected by adapting the voltage or changing an input resistance.

The invention will now be more particularly elucidated by means of examples.

### EXAMPLES

1. Materials Used
Various TPU formulations are used for the tests. The materials used are itemized hereinbelow.

1.1 TPU1
A thermoplastic polyurethane (TPU) having a Shore hardness of about 85 A is synthesized from 344 parts of 4,4′-diphenylmethane diisocyanate, 72.2 parts of 1,4-butanediol chain extender and 573 parts of polytetrahydrofuran having a number average molar mass of 1 kg/mol in a reactive extruder, wherein the zone temperatures are between 140° C. and 210° C. Further, 10 parts of a phenolic antioxidant and 25 ppm of a 25% solution of stannons dioctoate in dioctyl adipate as reaction catalyst are added. The TPU formed is shaped into lenticular pellets by underwater pelletization and dried.

1.2 TPU2
A thermoplastic polyurethane (TPU) having a Shore hardness of about 70 A is synthesized from 256 parts of 4,4′-diphenylmethane diisocyanate, 45.3 parts of 1,4-butanediol chain extender and 688 parts of polytetrahydrofuran having a number average molar mass of 1.5 kg/mol in a reactive extruder, wherein the zone temperatures are between 140° C. and 210° C. Further, 10 parts of a phenolic antioxidant, 5 parts of ester wax and 25 ppm of a 25% solution of stannons dioctoate in dioctyl adipate as reaction catalyst were added. The TPU formed is shaped into lenticular pellets by underwater pelletization and dried.

1.3 TPU3
A thermoplastic polyurethane (TPU) having a Shore hardness of about 60 A is synthesized from 199 parts of 4,4′-diphenylmethane diisocyanate, 25 parts of monoethylene glycol chain extender and 764 parts of a polymer diol from adipic acid, 1,2-ethanediol, 1,4-butanediol, the latter in a 1:1 mass ratio, of 2000 g/mol number average molar mass in a reactive extruder, wherein the zone temperatures are between 140° C. and 210° C. Further, 7.6 parts of a hydrolysis stabilizer (oligomeric carbodiimide from TMDXI=tetramethylxylyl diisocyanate), 2 parts of a phenolic antioxidant and 3 parts of a lubricant (partially saponified montan acid ester) are added during the reaction. The TPU formed is shaped into lenticular pellets by underwater pelletization and dried.

1.4 CNT: Nanocyl NC7000, carbon nanotubes from Nanocyl SA, Belgium 1.5 CB: Carbon-Black, Printex XE 2B from Orion Engineered Carbons, Germany

2. Preparation Examples

2.1 Example 1
A mixture of 97 parts by weight of TPU1 and 3 parts by weight of CNT was compounded on a Leistritz ZSE Maxx 27 co-rotating 27 mm 2-screw extruder, strand extruded and then pelletized.

The uniformly colored pellet material obtained was continuously processed on an Arenz 30 mm extruder (from Arenz Germany) via a profiling mold into wiping blade profiles about 10 mm2 in cross section. A portion 10 cm in length was cut off from each, contacted at the ends with conductivity silver, and a voltage corresponding to that described in table 2 was applied and the resulting temperature was measured with an infrared camera as a function of time.

On a corresponding machine equipped with a flat sheet die, the material was processed in a continuous manner into a sheet 10 cm wide and 1.5 mm thick. Test specimens were subsequently die-cut out of the sheet and their specific volume resistivity was measured as per ISO 3915.

2.2 Example 2
A mixture of 85 parts by weight of TPU1 and 15 parts by weight of CB was compounded on a Berstorff ZE 40 co-rotating 2-screw extruder, and subsequently pelletized under water.
The uniformly colored pellet material obtained was continuously processed on an Arenz 30 mm extruder (from Arenz Germany) via a profiling mold into wiping blade profiles about 10 mm2 in cross section. A portion 10 cm in length was cut off from each, contacted at the ends with conductivity silver, and a voltage corresponding to that described in table 2 was applied and the resulting temperature was measured with an infrared camera as a function of time.
On a corresponding machine equipped with a flat sheet die, the material was processed in a continuous manner into a sheet 10 cm wide and 1.5 mm thick.
Test specimens were subsequently die-cut out of the sheet and their specific volume resistivity was measured as per ISO 3915.

2.3 Example 3
A mixture of 97 parts by weight of TPU2 and 3 parts by weight of CNT was compounded on a Leistritz ZSE Maxx 27 co-rotating 27 mm 2-screw extruder, strand extruded and then pelletized.
The uniformly colored pellet material obtained was continuously processed on an Arenz 30 mm extruder (from Arenz Germany) via a flat sheet die into a sheet 10 cm wide and 1.5 mm thick.
Test specimens were subsequently die-cut out of the sheet and their specific volume resistivity was measured as per ISO 3915.

2.4 Example 4
A mixture of 97 parts by weight of TPU2 and 5 parts by weight of CNT was compounded on a Leistritz ZSE Maxx 27 co-rotating 27 mm 2-screw extruder, strand extruded and then pelletized.
The uniformly colored pellet material obtained was continuously processed on an Arenz 30 mm extruder (from Arenz Germany) via a profiling mold into wiping blade profiles about 10 mm2 in cross section. A portion 10 cm in length was cut off from each, contacted at the ends with conductivity silver, and a voltage corresponding to that described in table 2 was applied and the resulting temperature was measured with an infrared camera as a function of time.
On a corresponding machine equipped with a flat sheet die, the material was processed in a continuous manner into a sheet 10 cm wide and 1.5 mm thick.
Test specimens were subsequently die-cut out of the sheet and their specific volume resistivity was measured as per ISO 3915.

2.5 Example 5
A mixture of 97 parts by weight of TPU3 and 3 parts by weight of CNT was compounded on a Leistritz ZSE Maxx 27 co-rotating 27 mm 2-screw extruder, strand extruded and then pelletized.
The uniformly colored pellet material obtained was continuously processed on an Arenz 30 mm extruder (from Arenz Germany) via a flat sheet die into a sheet 10 cm wide and 1.5 mm thick.
Test specimens were subsequently die-cut out of the sheet and their specific volume resistivity was measured as per ISO 3915.

2.6 Example 6
A mixture of 95 parts by weight of TPU3 and 5 parts by weight of CNT was compounded on a Leistritz ZSE Maxx 27 co-rotating 27 mm 2-screw extruder, strand extruded and then pelletized.
The uniformly colored pellet material obtained was continuously processed on an Arenz 30 mm extruder (from Arenz Germany) via a profiling mold into wiping blade profiles about 10 mm2 in cross section. A portion 10 cm in length was cut off from each, contacted at the ends with conductivity silver, and a voltage corresponding to that described in table 2 was applied and the resulting temperature was measured with an infrared camera as a function of time.
On a corresponding machine equipped with a flat sheet die, the material was processed in a continuous manner into a sheet 10 cm wide and 1.5 mm thick.
Test specimens were subsequently die-cut out of the sheet and their specific volume resistivity was measured as per ISO 3915.

3. Results/Measured Values

Table 1 shows the results of volume resistivity measurement to ISO 3915.

| Example | VR [Ωcm] |
|---|---|
| 1 | 6 |
| 2 | 4 |
| 3 | 12 |
| 4 | 4 |
| 5 | 15 |
| 6 | 4 |

Table 2 summarizes applied voltages and the resulting temperatures measured with an infrared camera as a function of time.

| | Voltage | | | |
|---|---|---|---|---|
| | 12 V | | 24 V | |
| Temperature | after 1 min | after 5 min | after 1 min | after 5 min |
| Example 1 | 27° C. | 31° C. | 37° C. | 57° C. |
| Example 2 | 33° C. | 43° C. | 55° C. | >80° C. |
| Example 4 | 31° C. | 41° C. | 54° C. | >80° C. |
| Example 6 | 32° C. | 42° C. | 57° C. | >80° C. |

1. A method for manufacturing an electrically heatable shaped article for an automotive sector, the method comprising:
employing a composition (Z1) comprising an elastomer (E1) and at least 90% carbon-based conductivity-conferring additive (A1),
wherein
said at least one carbon-based conductivity-conferring additive (A1) is graphene, and said composition (Z1) has the following properties:
a Shore hardness A, determined per DIN 53505, in a range from 30 to 95,
an electric specific volume resistivity, determined per ISO 3915, of below 1×10² ohm×cm and above 0.01 ohm×cm, and
a breaking extension, determined per DIN 53504, of above 300%.

2. The method according to claim 1, wherein said elastomer (E1) is a thermoplastic polyurethane.

3. The method of using a composition (Z1) according to claim 1, or wherein said elastomer (E1) is a thermoplastic polyurethane based on at least one isocyanate, at least a first polyol component having a molecular weight of above 500 g/mol and at least a second polyol component having a molecular weight of below 499 g/mol.

4-5. (canceled)

6. The method according to claim 1, wherein said at least 90% carbon-based conductivity-conferring additive (A1) is present in said composition (Z1) in an amount ranging from 0.1 to 30 wt %, based on a total weight of the composition (Z1).

7. The method according to claim 1, wherein said composition (Z1) has a Shore hardness A, determined per DIN 53505, in a range from 40 to 85.

8. The method according to claim 1, wherein said composition (Z1) has a breaking extension, determined per DIN 53504, in a range above 500%.

9. The method according to claim 1, wherein said composition (Z1) has an electric specific volume resistivity, determined per ISO 3915, in a range from 0.1 to 5 ohm×cm.

10. The method according to claim 1, wherein the electrically heatable shaped article for an automotive sector is a stripper device, a wiping blade, a sealing lip, a steering wheel, a gasket or a component part for an automotive seat or an armrest.

11. A method of preparing an electrically heatable shaped article for an automotive sector, the method comprising
(i) providing a composition (Z1) comprising an elastomer (E1) and at least 90% carbon-based conductivity-conferring additive (A1), wherein said at least 90% carbon-based conductivity-conferring additive (A1) is graphene, and said composition (Z1) has the following properties:
a Shore hardness A, determined per DIN 53505, in a range from 30 to 95,
an electric specific volume resistivity, determined per ISO 3915, of below 1×10² ohm×cm and above 0.01 ohm×cm, and
a breaking extension, determined per DIN 53504, of above 300%, and
(ii) shaping said composition (Z1).

12. An electrically heatable shaped article for an automotive sector, comprising
a composition (Z1) comprising an elastomer (E1) and at least 90% carbon-based conductivity-conferring additive (A1),
wherein
said at least 90% carbon-based conductivity-conferring additive (A1) is graphene, and
said composition (Z1) has the following properties:
a Shore hardness A, determined per DIN 53505, in a range from 30 to 95,
an electric specific volume resistivity, determined per ISO 3915, of below 1×10² ohm×cm and above 0.01 ohm×cm, and
a breaking extension, determined per DIN 53504, of above 300%.

13. The shaped article according to claim 12, which is a stripper device, a wiping blade, a sealing lip, a steering wheel, a component part for an automotive seat or an armrest or a gasket.

14. The shaped article according to claim 12, which is heated by applying a direct or alternating current voltage from an automotive on-board network.

15. The shaped article according claim 12, wherein a temperature control of the shaped article is effected by adapting voltage or changing an input resistance.
